(19) United States
(12) Patent Application Publication
(10) Pub. No.: US 2013/0189582 A1
(43) Pub. Date: Jul. 25, 2013

(54) COMPOSITE ANODE ACTIVE MATERIAL, METHOD OF PREPARING COMPOSITE ANODE ACTIVE MATERIAL, AND ANODE AND LITHIUM BATTERY INCLUDING COMPOSITE ANODE ACTIVE MATERIAL

(71) Applicant: Jong-Hee Lee, Yongin-si (KR)

(72) Inventor: Jong-Hee Lee, Yongin-si (KR)

(73) Assignee: Samsung SDI Co., Ltd., Yongin-si (KR)

(21) Appl. No.: 13/572,426

(22) Filed: Aug. 10, 2012

(30) Foreign Application Priority Data
Jan. 19, 2012 (KR) 10-2012-0006405

(51) Int. Cl. H01M 4/131; H01M 4/139; H01M 4/04; H01M 4/133; H01M 4/134; B82Y 99/00

(52) U.S. Cl. 429/225; 429/231.1; 429/226; 429/231.8; 264/614; 977/948

(57) ABSTRACT

A composite anode active material includes a porous secondary particle formed by assembly of primary particles that includes metal nanoparticles capable of forming alloys with lithium and lithium titanate.

### CLAIM OF PRIORITY

This application makes reference to, incorporates the same herein, and claims all benefits accruing under 35 U.S.C. §119 from an application earlier filed in the Korean Intellectual Property Office on 19 Jan. 2012 and there duly assigned Serial No. 10-2012-0006405.

### BACKGROUND OF THE INVENTION

1. Field of the Invention

One or more embodiments of the present invention relate to a composite anode active material, a method of preparing the composite anode active material, and an anode and lithium battery including the composite anode active material.

2. Description of the Related Art

Carbonaceous materials such as graphite are representative examples of anode active materials for lithium batteries. Graphite has excellent capacity retention characteristics and excellent voltage characteristics. In addition, graphite does not vary in volume when it is used to form an alloy with lithium. Therefore, anode active materials including graphite may improve the stability of a battery. Graphite has a theoretical electrical capacity of about 372 mAh/g and a high irreversible capacity.

In addition, metals capable of forming alloys with lithium may be used as an anode active material for lithium batteries that has a higher electrical capacity than that of carbonaceous materials. Examples of metals capable of forming alloys with lithium include silicon (Si), tin (Sn), aluminum (Al), and the like. These metals have a very high electrical capacity. For example, a theoretical storage capacity of Si is 4,200 mAh/g. Such metals undergo volumetric expansion during charging and discharging of the batteries, thereby electrically isolating the active material within the electrode. In addition, an electrolyte decomposition reaction becomes severe, due to an increase in specific surface area of the active material. Moreover, a lithium battery including metals capable of forming alloys with lithium exhibits reduced capacity retention characteristics. For example, when the batteries are repeatedly charged and discharged, Si particles in the anode active material repeatedly aggregate with each other and are repeatedly crushed; therefore, Si is electrically disconnected from a current collector. Furthermore, metals capable of forming alloys with lithium are thermally unstable and thus problems such as thermal runaway may occur. Such metals have side reactions at the surface thereof and are involved in the formation of an electrolyte membrane, thereby reducing high rate characteristics of a battery.

Therefore, there is a need to develop a method of manufacturing a lithium battery that includes a metal capable of forming alloys with lithium and has high capacity and excellent lifetime characteristics, high rate characteristics and thermal stability.

### SUMMARY OF THE INVENTION

One or more embodiments of the present invention provide a composite anode active material that is porous and includes metal nanoparticles and lithium titanate.

One or more embodiments of the present invention provide a method of preparing the composite anode active material.

One or more embodiments of the present invention provide an anode including the composite anode active material.

One or more embodiments of the present invention provide a lithium battery including the anode.

Additional aspects will be set forth in part in the description which follows and, in part, will be apparent from the description, or may be learned by practice of the presented embodiments.

In accordance with one or more embodiments of the present invention, a composite anode active material includes a porous secondary particle formed by assembly of primary particles. The porous secondary particle includes metal nanoparticles capable of forming alloys with lithium and lithium titanate.

In accordance with one or more embodiments of the present invention, a method of preparing a composite anode active material includes mixing metal nanoparticles capable of forming alloys with lithium, a lithium-containing precursor, a titanium-containing precursor, and a solvent to prepare a mixture slurry; drying the mixture slurry to prepare spherical particles; and sintering the spherical particles to prepare a spherical porous secondary particle including lithium titanate.

In accordance with one or more embodiments of the present invention, an anode includes the composite anode active material.

In accordance with one or more embodiments of the present invention, a lithium battery includes the anode.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a scanning electron microscopic (SEM) image of a composite anode active material prepared according to Example 1;

FIG. 2 is an enlarged view of the image of FIG. 1, according to the principle of an embodiment of the present invention; and

FIG. 3 is a schematic view of a lithium battery constructed with the principle of another embodiment of the present invention.

### DETAILED DESCRIPTION OF THE INVENTION

Reference will now be made in detail to embodiments, examples of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain aspects of the present description. Expressions such as “at least one of,” when preceding a list of elements, modify the entire list of elements and do not modify the individual elements of the list.

Hereinafter, embodiments of a composite anode active material, a method of preparing the composite anode active material, an anode including the composite anode active material, and a lithium battery including the anode will be described in detail with reference to the accompanying drawings.

In accordance with an embodiment of the present invention, a composite anode active material includes a porous secondary particle formed by assembly of primary particles, in which the porous secondary particle includes metal nanoparticles capable of forming alloys with lithium and lithium titanate. In the composite anode active material, lithium titanate may be formed on at least a portion of a surface of the metal nanoparticle. The metal nanoparticles may be partially or completely coated with lithium titanate.

Since the composite anode active material includes the metal nanoparticles, a lithium battery including the composite anode active material may have an improved electrical capacity. In addition, the porous secondary particle may accept a change in volume of the metal nanoparticles and thus a lithium battery including the composite anode active material may exhibit improved lifetime characteristics. Moreover, lithium titanate having a spinel structure has a high operating voltage of about 1.5 V with respect to lithium metal and excellent thermal stability, and thus prevents side reactions between the metal nanoparticles and an electrolyte, thereby improving lifetime characteristics and thermal stability of a battery. In particular, lithium titanate having a spinel structure has high conductivity for lithium ions in terms of crystal structure, and thus, a lithium battery including the composite anode active material may exhibit improved high rate characteristics.

The porous secondary particle formed by assembly of primary particles may be an assembled structure or granule of primary particles. For example, the porous secondary particle may be an assembled structure of primary particles having a diameter ranging from about 0.1 to about 1 μm. The porous secondary particle may have a diameter ranging from about 1 to about 40 μm. The porous secondary particle having the diameter within the range described above is suitable for use in a lithium battery that provides improved performances.

The porous secondary particle may be spherical. For example, the porous secondary particle may have a spherical shape with a uniform particle diameter that has a sphericity of 0.90 or greater for a particle projected image. When the sphericity of the porous secondary particle is less than 0.90, it is difficult to perform uniform coating. The sphericity may be defined by Equation 1 below:

Sphericity=circumferential length of corresponding circle/circumferential length of particle projected image <Equation 1>

The porous secondary particle may be non-spherical. The non-spherical porous secondary particle may be formed by pulverizing the spherical porous secondary particle.

Pores of the porous secondary particle may have an irregular shape. The shape of the pores may include a variety of shapes such as a spherical shape, a non-spherical shape, and the like.

The porous secondary particle may have a pore size of 1 μm or less. For example, the size of the pores may range from about 0.01 to about 1 μm. The size of the pores refers to a size of pores viewed from the surface of the porous secondary particle. The porous secondary particle with the pore size within the range described above is suitable for use in a lithium battery that provides improved performances.

The amount of the metal nanoparticles may range from about 5 to about 60 wt % based on the total weight of the composite anode active material. The amount of the metal nanoparticles is however not particularly limited as long as it is within a range that improves performances of a lithium battery including the composite anode active material. For example, the amount of the metal nanoparticles may range from about 10 to about 20 wt % based on the total weight of the composite anode active material.

The metal nanoparticles may be at least one selected from the group consisting of silicon (Si), tin (Sn), aluminum (Al), germanium (Ge), plumbum (Pb), bismuth (Bi), stibium (Sb), and alloys thereof. The metal nanoparticles are however not limited to the above examples, and any metals capable of forming alloys with lithium that are known in the art may be used. For example, the metal nanoparticles may be Si nanoparticles.

The metal nanoparticles may have an average particle diameter of less than 500 nm. For example, the metal nanoparticles may have an average particle diameter ranging from about 10 to about 100 nm. The metal nanoparticles having the average particle diameter within the range described above is suitable for use in a lithium battery that provides improved performances.

The lithium titanate may have a spinel structure. Due to the spinel structure of the lithium titanate, a change in volume between lattices is suppressed during charging and discharging of a battery, and thus a lithium battery including the composite anode active material may exhibit improved lifetime characteristics. In addition, the lithium battery may have an improved high rate characteristic due to high ionic conductivity of the lithium titanate.

The lithium titanate may be represented by Formula 1 below, but is not limited thereto. That is, any lithium titanate known in the art may be used:

LiₓTi_{y}O₄ <Formula 1>

where 0.8≦x≦1.4 and 1.6≦y≦2.2

For example, the lithium titanate may be Li₄Ti₅O₁₂.

The composite anode active material may further include a carbonaceous material. The carbonaceous material may be partially or entirely formed on a surface of the metal nanoparticle. The carbonaceous material may also be partially or entirely formed on a surface of the lithium titanate. For example, the metal nanoparticle and/or the lithium titanate may be partially or completely coated with the carbonaceous material. Since the composite anode active material may further include the carbonaceous material, the conductivity of the composite anode active material may be further improved.

The carbonaceous material may be a low crystalline carbon or an amorphous carbon that has an interlayer spacing (d₀₀₂) of 3.45 Å or more. A low crystalline or amorphous carbonaceous material does not have side reactions with an electrolytic solution during charging and discharging, and thus decomposition of the electrolytic solution may be suppressed; therefore, high charge and discharge efficiencies may be obtained. The carbonaceous material may be a sintered product of a carbon precursor. Any low crystalline or amorphous carbonaceous material known in the art may be used as long as it does not have side reactions with an electrolytic solution.

In accordance with another embodiment of the present invention, a method of preparing a composite anode active material includes mixing metal nanoparticles capable of forming alloys with lithium, a lithium-containing precursor, a titanium-containing precursor, and a solvent to prepare a mixture slurry; drying the mixture slurry to prepare spherical particles; and sintering the spherical particles to prepare a spherical porous secondary particle including lithium titanate.

In the method of preparing a composite anode active material, the amount of the metal nanoparticles capable of forming alloys with lithium may be in the range of about 10 to about 60 wt % based on the total weight of the mixture slurry. The amount of the metal nanoparticles is however not limited to the above example and may be appropriately adjusted within a range that achieves the objective of the present invention.

The titanium-containing precursor may be at least one selected from the group consisting of titanium dioxide, titanium isopropoxide, titanium ethoxide, titanium propoxide, and titanium tetrachloride. The titanium-containing precursor is however not particularly limited thereto, and any titanium-containing precursor known in the art may be used.

The lithium-containing precursor may be at least one selected from the group consisting of lithium carbonate, lithium hydroxide, lithium chloride, and lithium nitrate. The lithium-containing precursor is however not particularly limited thereto, and any lithium-containing precursor known in the art may be used.

The solvent may be at least one selected from the group consisting of water, ethanol, methanol, isopropyl alcohol, butanol, and pentanol. The solvent is however not particularly limited thereto, and any solvent known in the art may be used.

The drying of the mixture slurry may be performed by spray drying using a spray dryer. A spray dryer used in the spray drying process may be at least one selected from the group consisting of a centrifugal type spray dryer, a pressure nozzle type spray dryer, and a two-fluid type spray dryer. The spray dryer is however not particularly limited thereto, and any spray dryer known in the art may be used.

For example, a pressure nozzle type spray dryer may be used to prepare coarse particles, and a centrifugal type spray dryer or a two-fluid type spray dryer may be used to prepare fine particles.

The amount of the solvent in the mixture slurry may range from about 20 to about 60 wt % based on the total weight of the mixture slurry. The amount of the solvent is however not limited thereto and may be appropriately adjusted within a range in which a mixture slurry with high dispersity and stability can be prepared.

The mixture slurry may further include additives such as a dispersing agent and a binder, but a stable slurry with high dispersity may be obtained without using such an additive.

The sintering of the spherical particles prepared by drying the mixture slurry may be performed at a temperature ranging from about 750 to about 950° C. The sintering temperature is however not particularly limited thereto and may be appropriately adjusted within a range in which a spherical porous secondary particle including lithium titanate can be prepared. For example, the sintering temperature of the spherical particles may range from about 800 to about 900° C.

The sintering of the spherical particles prepared by drying the mixture slurry may be performed for 1 to 20 hours. The sintering time is however not particularly limited thereto and may be appropriately adjusted within a range in which a spherical porous secondary particle including lithium titanate can be prepared. For example, the sintering time of the spherical particles may range from about 3 to about 15 hours.

The sintering of the spherical particles prepared by drying the mixture slurry may be performed in an inert atmosphere. The sintering atmosphere is however not particularly limited thereto and may be appropriately adjusted within a range in which a spherical porous secondary particle including lithium titanate can be prepared. For example, the sintering of the spherical particles may be performed in an atmosphere consisting of Ar, Ne, N₂, or a mixture thereof.

The method of preparing a composite anode active material may further include pulverizing the spherical porous secondary particle, after the preparation of the spherical porous secondary particle.

Through the pulverizing of the spherical porous secondary particle, a non-spherical porous secondary particle may be obtained.

In the method of preparing a composite anode active material, the mixture slurry may further include a carbon precursor. Due to the inclusion of the carbon precursor in the mixture slurry, the prepared spherical porous secondary particle may include a carbonaceous material. The carbonaceous material may further improve the conductivity of the spherical porous secondary particle.

The carbon precursor may be at least one of polymers and polyols. The carbon precursor is however not particularly limited thereto, and any carbon precursor known in the art, which is sintered to prepare a carbonaceous material, may be used. Examples of the polymers include a vinyl-based resin, a cellulose-based resin, a phenol-based resin, a pitch-based resin, and a tar-based resin. For example, the carbon precursor may be polyvinyl alcohol or sucrose.

In accordance with another embodiment of the present invention, an anode may include the composite anode active material. For example, the anode may be prepared as follows.

A composite anode active material, a conducting agent, a binder, and a solvent are mixed to prepare an anode active material composition, and then the anode active material composition may be directly coated on a copper current collector, to obtain an anode plate. Alternatively, the anode active material composition may be cast on a separate support, and then an anode active material film separated from the support is laminated on a copper current collector, to obtain an anode plate.

Examples of the conducting agent include carbon black, a graphite particulate, natural graphite, artificial graphite, acetylene black, Ketjen black, carbon fiber; carbonaceous materials such as carbon nanotubes; metal powder, fiber or tube of copper, nickel, aluminum, or silver; and conductive polymers such as polyphenylene derivatives. The conducting agent is however not limited thereto, and any conducting agent known in the art may be used.

Examples of the binder include a vinylidene fluoride/hexafluoropropylene copolymer, polyvinylidene fluoride, polyacrylonitrile, polymethylmethacrylate, polytetrafluoroethylene (PTFE), mixtures of the above-mentioned polymers, and a styrene butadiene rubber polymer. The solvent may be N-methyl-pyrrolidone (NMP), acetone, water, or the like. The binder and the solvent are however not limited to the above examples, and any binder and solvent known in the art may be used.

When desired, the anode active material composition may further include a plasticizer and thus pores may be formed in an electrode plate.

Amounts of the composite anode active material, the conducting agent, the binder, and the solvent may be used at the same levels as commercially used in a lithium battery. According to the application and structure of a lithium battery to be manufactured, at least one of the conducting agent, the binder, and the solvent may not be used.

Also, in addition to the composite anode active material, the anode may further include other general anode active materials. Any general anode active material for lithium batteries that is known in the art may be used. For example, a general anode active material may be at least one selected from the group consisting of lithium metal, metals capable of forming alloys with lithium, a transition metal oxide, a non-transition metal oxide, and carbonaceous materials.

Examples of metals capable of forming alloys with lithium include Si; Sn; Al; Ge; Pb; Bi; Sb; a Si—Y alloy where Y is an alkali metal, an alkali earth metal, a Group 13 element, a Group 14 element, a transition metal, a rare-earth element, or combinations thereof and is not Si; and a Sn—Y alloy where Y is an alkali metal, an alkali earth metal, a Group 13 element, a Group 14 element, a transition metal, a rare-earth element, or combinations thereof and is not Si. The element Y may be Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, or combinations thereof.

For example, the transition metal oxide may be a lithium titanium oxide, a vanadium oxide, or a lithium vanadium oxide.

For example, the non-transition metal oxide may be SnO₂ or SiOₓ where 0<x<2.

The carbonaceous material may be a crystalline carbon, an amorphous carbon, or mixtures thereof. Examples of the crystalline carbon include natural graphite and artificial graphite, each of which has an amorphous shape, a plate shape, a flake shape, a spherical shape, or a fiber shape. Examples of the amorphous carbon include soft carbon (low-temperature calcined carbon), hard carbon, meso-phase pitch carbide, and calcined coke.

In addition, except that the anode includes the composite anode active material, a preparation method, a composition, and a structure of the anode may be appropriately adjusted in order for the anode to be used in other electrochemical cells, such as a supercapacitor, as well as a lithium battery.

In accordance with another embodiment of the present invention, a lithium battery includes the anode including the composite anode active material. The lithium battery may be manufactured as follows.

First, an anode is prepared as described above.

Next, a cathode may be prepared as follows. The cathode may be prepared using the same method as that used to prepare the anode, except that a cathode active material is used instead of the composite anode active material.

A cathode active material, a conducting agent, a binder, and a solvent are mixed to prepare a cathode active material composition. In this regard, the conducting agent, the binder, and the solvent may be the same as those used to prepare the anode. Then, the cathode active material composition may be directly coated on an aluminum current collector and the coated aluminum current collector is dried to obtain a cathode plate on which a cathode active material layer is formed. Alternatively, the cathode active material composition may be cast on a separate support, and then a cathode active material film separated from the support is laminated on an aluminum current collector to obtain a cathode plate on which a cathode active material layer is formed.

Any lithium-containing metal oxide that is commonly used in the art may be used as the cathode active material. The lithium-containing metal oxide may be at least one selected from composite oxides of lithium and a metal selected from cobalt, manganese, nickel, and combinations thereof. In particular, the lithium-containing metal oxide may be a compound represented by any one of Formulae: LiₐA_{1-b}B_{b}D₂ where 0.90≦a≦1.8 and 0≦b≦0.5; LiₐE_{1-b}B_{b}O_{2-c}D_{c} where 0.90≦a≦1.8, 0≦b≦0.5, and 0≦c≦0.05; LiE_{2-b}B_{b}O_{4-c}D_{c} where 0≦b≦0.5 and 0≦c≦0.05; LiₐNi_{1-b-c}Co_{b}B_{c}D_{α} where 0.90≦a≦1.8, 0≦b≦0.5, 0≦c≦0.05, and 0<α≦2; LiₐNi_{1-b-c}CO_{b}B_{c}O_{2-α}F_{α} where 0.90≦a≦1.8, 0≦b≦0.5, 0≦c≦0.05, and 0≦α≦2; LiₐNi_{1-b-c}Co_{b}B_{c}O_{2-α}F₂ where 0.90≦a≦1.8, 0≦b≦0.5, 0≦c≦0.05, and 0<α≦2; LiₐNi_{1-b-c}Mn_{b}B_{c}D_{α} where 0.90≦a≦1.8, 0≦b≦0.5, 0≦c≦0.05, and 0<α≦2; LiₐNi_{1-b-c}Mn_{b}B_{c}O_{2-α}F_{α} where 0.90≦a≦1.8, 0≦b≦0.5, 0≦c≦0.05, and 0<α<2; LiₐNi_{1-b-c}Mn_{b}B_{c}O_{2-α}F₂ where 0.90≦a≦1.8, 0≦b≦0.5, 0≦c≦0.05, and 0<α≦2; LiₐNi_{b}E_{c}G_{d}O₂ where 0.90≦a≦1.8, 0≦b≦0.9, 0≦c≦0.5, and 0.001≦d≦0.1; LiₐNi_{b}Co_{c}Mn_{d}GeO₂ where 0.90≦a≦1.8, 0≦b≦0.9, 0≦c≦0.5, 0≦d≦0.5, and 0.001≦e≦0.1; LiₐNiG_{b}O₂ where 0.90≦a≦1.8 and 0.001≦b≦0.1; LiₐCoG_{b}O₂ where 0.90≦a≦1.8 and 0.001≦b≦0.1; LiₐMnG_{b}O₂ where 0.90≦a≦1.8 and 0.001≦b≦0.1; LiₐMn₂G_{b}O₄ where 0.90≦a≦1.8 and 0.001≦b≦0.1; QO₂; QS₂; LiQS₂; V₂O₅; LiV₂O₅; LiIO₂; LiNiVO₄; Li_{(3-f)}J₂(PO₄)₃ where 0≦f≦2; Li_{(3-f)}Fe₂(PO₄)₃ where 0≦f≦2; and LiFePO₄.

In the formulae above, A is Ni, Co, Mn, or combinations thereof; B is Al, Ni, Co, Mn, Cr, Fe, Mg, Sr, V, a rare-earth element, or combinations thereof; D is O, F, S, P, or combinations thereof; E is Co, Mn, or combinations thereof; F is F, S, P, or combinations thereof; G is Al, Cr, Mn, Fe, Mg, La, Ce, Sr, V, or combinations thereof; Q is Ti, Mo, Mn, or combinations thereof; I is Cr, V, Fe, Sc, Y, or combinations thereof; and J is V, Cr, Mn, Co, Ni, Cu, or combinations thereof.

For example, the cathode active material may be LiCoO₂, LiMnₓO₂ₓ where x=1 or 2, LiNi₁₋ₓMnₓO₂ₓ where 0<x<1, Ni_{1-x-y}CoₓMn_{y}O₂ where 0≦x≦0.5 and 0≦y≦0.5, or LiFePO₄.

The compounds described above may have a coating layer at their surfaces. Also, a compound without a coating layer and a compound with a coating layer may be used in combination. The coating layer may include a coating element compound, such as an oxide of a coating element, a hydroxide of a coating element, an oxyhydroxide of a coating element, an oxycarbonate of a coating element, or a hydroxy carbonate of a coating element. The coating element compounds may be amorphous or crystalline. The coating element included in the coating layer may be Mg, Al, Co, K, Na, Ca, Si, Ti, V, Sn, Ge, Ga, B, As, Zr, or mixtures thereof. A coating layer may be formed by using the coating elements in the aforementioned compounds by using any one of various methods that do not adversely affect physical properties of a cathode active material (e.g., spray coating or immersion). The coating layer formation methods may be obvious to one of ordinary skill in the art and thus, will not be described herein in detail.

The amounts of the cathode active material, the conducting agent, the binder, and the solvent may be the same level as those used in a general lithium battery.

Next, a separator interposed between the cathode and the anode is prepared. The separator may be any separator that is commonly used in lithium batteries. In particular, the separator may have low resistance to migration of ions in an electrolyte and may have a high electrolyte-retaining ability. Examples of the separator may include glass fiber, polyester, Teflon, polyethylene, polypropylene, polytetrafluoroethylene (PTFE), and combinations thereof, each of which may be a nonwoven fabric or a woven fabric. For example, a windable separator such as polyethylene, polypropylene or the like may be used for a lithium ion battery, and a separator that may retain a large amount of an organic electrolytic solution may be used for a lithium-ion polymer battery. For example, the separator may be prepared as follows.

A polymer resin, a filler, and a solvent are mixed to prepare a separator composition. The separator composition may be directly coated on an electrode, and then dried to form a separator. Alternatively, the separator composition may be cast on a support and dried, and a separator film separated from the support is then laminated on the electrode, thereby completing the preparation of a separator.

Any polymer resin that is commonly used for binding electrode plates in lithium batteries may be used without limitation. Examples of the polymer resin include polyethylene, polypropylene, a polyethylene/polypropylene copolymer, a vinylidenefluoride/hexafluoropropylene copolymer, polyvinylidene fluoride (PVDF), polyacrylonitrile, polymethylmethacrylate, and mixtures thereof.

Next, an electrolyte is prepared.

For example, the electrolyte may be an organic electrolytic solution. In addition, the electrolyte may be in a solid form. Examples of the electrolyte include boron oxides, lithium oxynitride, and the like. The electrolyte is however not limited to the above examples, and may be any solid electrolyte used in the art. The solid electrolyte may be formed on the anode by sputtering.

For example, an organic electrolytic solution may be prepared by dissolving a lithium salt in an organic solvent.

Any organic solvent used in the art may be used. Examples of the organic solvent include propylene carbonate, ethylene carbonate, fluoroethylene carbonate, butylene carbonate, dimethyl carbonate, diethyl carbonate, methylethyl carbonate, methylpropyl carbonate, ethylpropyl carbonate, methylisopropyl carbonate, dipropyl carbonate, dibutyl carbonate, benzonitrile, acetonitrile, tetrahydrofuran, 2-methyltetrahydrofuran, γ-butyrolactone, dioxorane, 4-methyldioxorane, N,N-dimethyl formamide, dimethyl acetamide, dimethylsulfoxide, dioxane, 1,2-dimethoxyethane, sulforane, dichloroethane, chlorobenzene, nitrobenzene, diethylene glycol, dimethyl ether, and mixtures thereof.

Any lithium salt that is commonly used in the art may be used. For example, the lithium salt may be LiPF₆, LiBF₄, LiSbF₆, LiAsF₆, LiClO₄, LiCF₃SO₃, Li(CF₃SO₂)₂N, LiC₄F₉SO₃, LiAlO₂, LiAlCl₄, LiN(CₓF₂ₓ₊₁SO₂)(C_{y}F_{2y+1}SO₂) where x and y are independently a natural number, LiCl, LiI, or a mixture thereof.

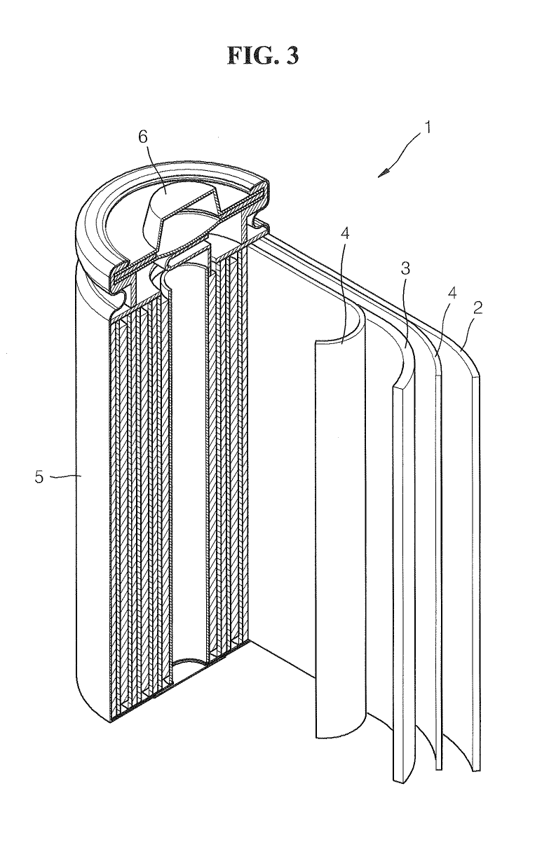

FIG. 3 is a schematic view of a lithium battery 1 according to an embodiment of the present invention. The lithium battery 1 includes a cathode 3, an anode 2, and a separator 4. The cathode 3, the anode 2, and the separator 4 are wound or folded, and then accommodated in a battery case 5. Subsequently, an organic electrolyte is injected into the battery case 5 and the battery case 5 is sealed by a cap assembly 6, thereby completing the manufacture of the lithium battery 1. The battery case 5 may have a cylindrical shape, a rectangular shape or a thin-film shape. For example, the lithium battery 1 may be large-size thin-film-type battery. The lithium battery 1 may be a lithium ion battery.

The separator 4 may be disposed between the cathode 3 and the anode 2 to form a battery assembly. A plurality of battery assemblies may be stacked in a bi-cell structure and impregnated into an organic electrolytic solution. The resultant is put into a pouch and hermetically sealed, thereby completing the manufacture of a lithium ion polymer battery.

In addition, the plurality of battery assemblies are stacked to form a battery pack, and such a battery pack may be used in any devices requiring high capacity and high-power output. For example, the battery pack may be used in notebook computers, smart phones, or electric vehicles.

A lithium battery including the anode including the composite anode active material has high thermal stability, excellent lifetime characteristics, and high rate characteristics, and thus may be used in electric vehicles, power tools, and portable electronic devices.

One or more embodiments will now be described in further detail with reference to the following examples. These examples are for illustrative purposes only and are not intended to limit the scope of the one or more embodiments.

### Preparation of Composite Anode Active Material

### Example 1

125 g of powder of Si nanoparticles having an average diameter of 30 nm was added to 2887 g of distilled water and dispersed therein, 416 g of lithium carbonate (Li₂CO₃) and 1100 g of titania (TiO₂) were added thereto, and the resultant mixture was then stirred at room temperature for 30 minutes by using an agitator. The stirred solution was wet mixed by bead milling for 40 minutes to prepare a mixture slurry. The mixture slurry was spray dried using a spray dryer to prepare a spherical particle powder. The spraying conditions were as follows: a spray inlet temperature of 200° C., a spray outlet temperature of 150° C., and a disk rotating speed of 10,000 rpm. The spray dryer used was a pressure nozzle type spray dryer (FCNM-017PN, Dongjin Technology Institute Co.). The obtained spherical particle powder was put in an aluminum crucible, the temperature of the aluminum crucible was raised to 830° C. at a heating rate of 5° C./min in an inert atmosphere, and the spherical particle powder was sintered at 830° C. for 5 hours. The sintered product was disintegrated and classified to prepare as a composite anode active material which has a porous secondary particle powder Li₄Ti₅O₁₂ including Si nanoparticles. The amount of the Si nanoparticles in the composite anode active material was 10 wt % based on the total weight of the composite anode active material.

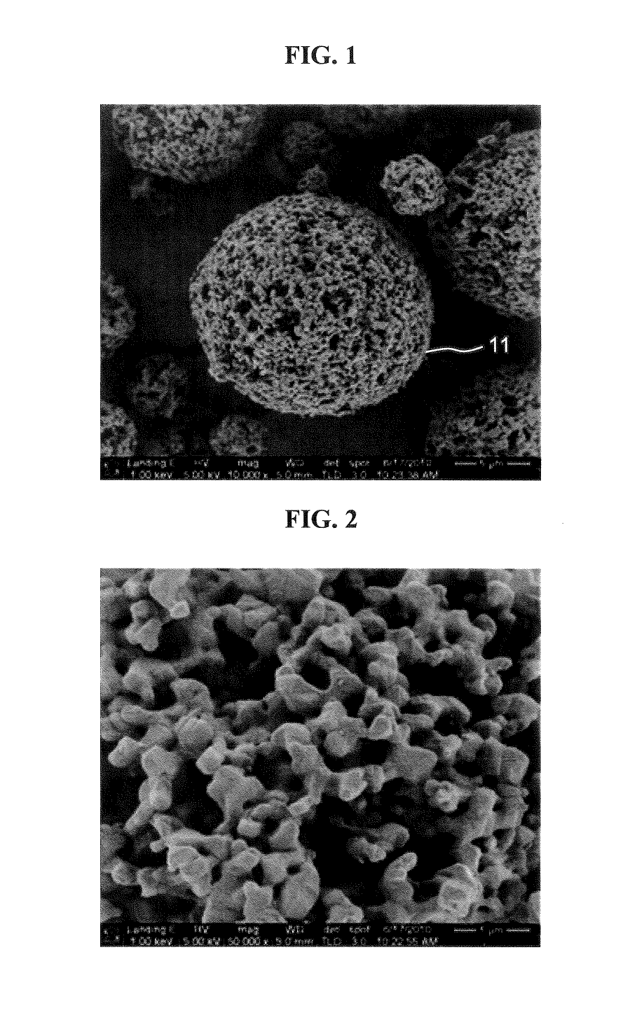

Scanning electron microscopic (SEM) images of the prepared composite anode active material are shown in FIGS. 1 and 2. As shown in FIGS. 1 and 2, the composite anode active material consisted of a spherical porous secondary particle. In FIG. 2, the spherical porous secondary particle 11 of FIG. 1 is enlarged to clearly show the porous structure.

The spherical porous secondary particle had a diameter ranging from about 2 to about 20 μm and had a pore size of less than 1 μm. The spherical porous secondary particle had an irregularity on its surface. The diameter of primary particles constituting the spherical porous secondary particle ranged from about 0.1 to about 1 μm. The spherical porous secondary particle had a sphericity of 0.94.

### Example 2

A composite anode active material was prepared in the same manner as in Example 1, except that the composition of the reactants was changed so that Si accounted for 50 wt % of the composite anode active material.

### Example 3

A composite anode active material was prepared in the same manner as in Example 1, except that the composition of the reactants was changed so that Si accounted for 2 wt % of the composite anode active material.

### Example 4

A composite anode active material was prepared in the same manner as in Example 1, except that the composition of the reactants was changed so that Si accounted for 65 wt % of the composite anode active material.

### Comparative Example 1

Powder of Si nanoparticles having an average diameter of 30 nm was itself used as an anode active material.

### Comparative Example 2

A composite anode active material was prepared in the same manner as in Example 1, except that the Si nanoparticles were not used. The obtained anode active material was porous secondary particle powder Li₄Ti₅O₁₂ not including Si nanoparticles.

### Manufacture of Anode and Lithium Battery

### Example 5

The composite anode active material prepared according to Example 1, a carbon conducting agent (Super-P, Timcal Inc.), and polyvinylidene fluoride (PVDF) as a binder were mixed at a weight ratio of 90:4:6 and the mixture was mixed with N-methylpyrrolidone NMP in an agate mortar to prepare an anode active material slurry. Then, the anode active material slurry was coated on a copper current collector to a thickness of about 50 μm by using a doctor blade, and the coated copper current collector was dried at room temperature for 2 hours and then was subjected to a pressing process. The pressed structure was dried in vacuum at 130° C. for 12 hours, thereby completing the manufacture of an anode plate.

The anode plate, a lithium metal as a counter electrode, a polypropylene separator (Cellgard 3510), and an electrolytic solution obtained by dissolving 1 M of LiPF₆ in a mixed solvent of ethylene carbonate (EC) and dimethyl carbonate (DMC) (weight ratio of 1:1) were used to manufacture a coin cell.

### Examples 6 through 8

Lithium batteries were manufactured in the same manner as in Example 5, except that the composite anode active materials prepared according to Examples 2 to 4 were respectively used.

### Comparative Examples 3 and 4

Lithium batteries were manufactured in the same manner as in Example 5, except that the composite anode active materials prepared according to Comparative Examples 1 and 2 were respectively used.

### Evaluation Example 1

### Charge-Discharge Test

The lithium batteries manufactured according to Examples 5 through 8 and Comparative Examples 3 and 4 were charged with a current of 0.1 C-rate until the voltage thereof reached 0.01 V (with respect to the Li metal), and then discharged at the same current until the voltage thereof reached 3 V (with respect to the Li metal). Then, the cycle of charging and discharging was repeatedly performed 50 times at the same current and voltage range.

A discharge capacity at 1^{st} cycle, an initial charge and discharge efficiency, and a cycle retention rate of each of the lithium batteries of Examples 5 through 8 and Comparative Examples 3 and 4 are shown in Table 1 below. The cycle retention rate is defined by Equation 2 below, and the initial charge and discharge efficiency is defined by Equation 3 below:

Cycle retention rate [%]=[discharge capacity at 50^{th} cycle/discharge capacity at 2^{nd} cycle]×100 <Equation 2>

Initial charge and discharge efficiency [%]=[discharge capacity at 1^{st} cycle/charge capacity at 1^{st} cycle]×100 <Equation 3>

TABLE 1

| | Discharge capacity | Initial charge | |
|---|---|---|---|
| | at 1^{st} cycle | and discharge | Cycle retention |
| | [mAh/g] | efficiency [%] | rate [%] |
| Example 5 | 982 | 92 | 95 |
| Example 6 | 1094 | 90 | 94 |
| Example 7 | 673 | 93 | 92 |
| Example 8 | 1154 | 81 | 83 |
| Comparative | 1283 | 56 | 14 |
| Example 3 | | | |
| Comparative | 173 | 99 | 99 |
| Example 4 | | | |

As shown in Table 1, the initial charge and discharge efficiencies of the cycle retention rates of the lithium batteries of Examples 5 to 8 were higher than those of the lithium battery of Comparative Example 3, and the discharge capacity of each of the lithium batteries of Examples 5 to 8 was higher than that of the lithium battery of Comparative Example 4.

### Evaluation Example 2

### Measurement of Calorific Value

The lithium batteries of Examples 5 through 8 and Comparative Examples 3 and 4 were subjected to one cycle of charging and discharging with a constant current of 0.05 C-rate at a voltage ranging from about 0.01 to about 3 V with respect to the Li metal at 25° C.

Then, each lithium battery was charged once at 25° C. with a constant current of 0.1 C-rate until the voltage thereof reached 0.01 V with respect to the Li metal.

Afterwards, the charged lithium batteries were broken, anode active materials were taken out of the lithium batteries, and differential scanning calorimeter (DSC) analysis was performed on each anode active material. The analysis results are shown in Table 2 below. In FIG. 2, the calorific values were calculated as integrated quantities of a heat flux curve.

TABLE 2

| | Calorific values |
|---|---|
| | [J/g] |
| Example 5 | 135 |
| Example 6 | 277 |
| Example 7 | 96 |
| Example 8 | 345 |
| Comparative | 634 |
| Example 3 | |
| Comparative | 67 |
| Example 4 | |

As shown in Table 2, the anode active materials of Examples 1 to 4 respectively used to manufacture the lithium batteries of Example 5 to 8 exhibited a reduced calorific value as compared to that of the anode active material of Comparative Example 1 used to manufacture the lithium battery of Comparative Example 3.

Therefore, the anode active materials of Examples 1 to 4 had a higher thermal stability than that of the anode active material of Comparative Example 1.

As described above, according to the one or more of the above exemplary embodiments of the present invention, a composite anode active material is porous and includes metal nanoparticles and lithium titanate. Thus, a lithium battery including the composite anode active material may have high discharge capacity and thermal stability and excellent lifetime characteristics and high rate characteristics.

It should be understood that the exemplary embodiments described therein should be considered in a descriptive sense only and not for purposes of limitation. Descriptions of features or aspects within each embodiment should typically be considered as available for other similar features or aspects in other embodiments.

What is claimed is:

1. A composite anode active material comprising a porous secondary particle formed by assembly of primary particles, the porous secondary particle comprising metal nanoparticles capable of forming alloys with lithium and lithium titanate.

2. The composite anode active material of claim 1, wherein the metal nanoparticles are coated with the lithium titanate.

3. The composite anode active material of claim 1, wherein the porous secondary particle has a diameter ranging from about 1 to about 40 μm.

4. The composite anode active material of claim 1, wherein the porous secondary particle has a sphericity of 0.90 or more.

5. The composite anode active material of claim 1, wherein the porous secondary particle is non-spherical.

6. The composite anode active material of claim 1, wherein pores of the porous secondary particle have an irregular shape.

7. The composite anode active material of claim 1, wherein pores of the porous secondary particle have a size of less than 1 μm.

8. The composite anode active material of claim 1, wherein an amount of the metal nanoparticles is in a range of from about 5 to about 60 wt % based on the total weight of the composite anode active material.

9. The composite anode active material of claim 1, wherein the metal nanoparticles comprise at least one selected from the group consisting of Si, Sn, Al, Ge, Pb, Bi, Sb, and alloys thereof.

10. The composite anode active material of claim 1, wherein the metal nanoparticles have an average diameter of less than 500 nm.

11. The composite anode active material of claim 1, wherein the lithium titanate is represented by
LiₓTi_{y}O₄
where 0.8≦x≦1.4 and 1.6≦y≦2.2.

12. The composite anode active material of claim 1, further comprising a carbonaceous material.

13. The composite anode active material of claim 12, wherein the carbonaceous material is a low crystalline carbon or an amorphous carbon that has an interlayer spacing (d₀₀₂) of 3.45 Å or more.

14. A method of preparing a composite anode active material, the method comprising:
preparing a mixture slurry by mixing metal nanoparticles capable of forming alloys with lithium, a lithium-containing precursor, a titanium-containing precursor, and a solvent;
preparing spherical particles by drying the mixture slurry; and
preparing a spherical porous secondary particle including lithium titanate by sintering the spherical particles.

15. The method of claim 14, wherein the titanium-containing precursor comprises at least one selected from the group consisting of titanium dioxide, titanium isopropoxide, titanium ethoxide, titanium propoxide, and titanium tetrachloride.

16. The method of claim 14, wherein the step of drying the mixture slurry is performed using a spray dryer.

17. The method of claim 14, wherein an amount of the solvent in the mixture slurry is in a range of about 20 to about 60 wt % based on the total weight of the mixture slurry.

18. The method of claim 14, further comprising pulverizing the spherical porous secondary particle.

19. The method of claim 14, wherein the mixture slurry further comprises a carbon precursor.

20. A lithium battery comprising the composite anode active material according to claim 1.
